(19) United States
(12) Patent Application Publication
(10) Pub. No.: US 2007/0017160 A1
(43) Pub. Date: Jan. 25, 2007

(54) Composite materials and method for making same

(76) Inventors: Steven G. Caldwell, Hendersonville, TN (US); James J. Oakes, Madison, AL (US)

Correspondence Address: ALLEGHENY TECHNOLOGIES, 1000 SIX PPG PLACE, PITTSBURGH, PA, 15222, US

(21) Appl. No.: 11/490,433

(22) Filed: Jul. 20, 2006

Related U.S. Application Data
(60) Provisional application No. 60/701,547, filed on Jul. 22, 2005.

(51) Int. Cl. C09K 3/14; C08J 5/14

(52) U.S. Cl. 51/298; 51/307; 51/308; 51/309; 523/149; 524/406

(57) ABSTRACT

Certain non-limiting embodiments of the present disclosure comprise a family of composite materials targeting specific applications through a materials design approach involving; 1) a hard particulate; 2) a carrier or binder phase; and 3) one or more additives for property enhancement and/or hardness adjustment. According to certain embodiments, the composite material may be one of flexible conformal sheet; a rigid machinable molded preform; and an extrudable putty. Methods of manufacture of the composite materials are also disclosed.

### CROSS REFERENCE TO RELATED APPLICATIONS

This application claims priority to United States Provisional Application No. 60/701,547 filed Jul. 22, 2005, the disclosure of which is incorporated in its entirety by reference herein.

### BACKGROUND

1. Field of the Technology

Certain non-limiting embodiments of the present disclosure comprise a family of composite materials targeting specific applications through a materials design approach including the materials: 1) a hard particulate; 2) a carrier or binder phase; and 3) one or more additives for property enhancement and/or hardness adjustment. According to certain non-limiting embodiments, the composite materials may be one of flexible conformal sheet; a rigid machinable molded preform; and an extrudable putty. Methods of manufacturing the composite materials are also disclosed.

2. Background of the Technology

There is currently a wide range of materials in use that have some manifestation of hardness or density as a prime characteristic of interest. Virtually all of these known products, including such items as hardfacing electrodes, vitrified bond abrasive tools, and sintered tungsten alloys represent mature materials technologies. It is not uncommon to find either emerging or evolved applications that are not well met by existing, mature products. Contemporary drivers for new materials include minimized toxicity, easier use in outsourced, focused manufacturing operations, and more cost effective means of providing the same material properties of interest.

Finely divided metals have been employed in the past in admixture with thermoplastic and thermosetting resins to impart various properties, such as, for example, heat conductivity, reflective effects, and thermal stability. It has also been recognized that metal powders can be compacted without added resins, and a subsequent sintering operation can be used to bind the metal particles together.

The typical composite material is a system comprising two or more materials on a fine scale. The purpose of such a combination is to create a new material possessing a set of characteristics of interest, wherein each set of characteristics is derived from the combined presence of each of the individual components but not present as a set in any separate component.

Many traditional composite materials have strong, stiff fibers in a matrix which is weaker and less stiff. The objective is usually to make a component which is strong and stiff, often with a desired density. Commercial material commonly has glass or carbon fibers in matrices based on thermosetting polymers, such as epoxy or polyester resins. Sometimes, thermoplastic polymers may be preferred, since they are moldable after initial production. There are further classes of composites in which the matrix is a metal or a ceramic. Furthermore in these composites, the reasons for adding the fiber are often rather complex; for example, improvements may be sought in creep, wear, fracture toughness, thermal stability, etc.

Inorganic-organic composite materials have been used with varying degrees of success for a variety of applications. Polymer-metal composite materials are of increasing importance in a number of industries, due to the fact that polymer-metal composite materials offer characteristics which are difficult or impossible to match with other materials of equivalent price or ease of manufacture. Polymer-metal composites are defined as materials having a polymer matrix containing metallic particles distributed therein. The use of polymer-metal composites has proved advantages in numerous applications, including, for example, high density lead-free ammunition.

### BRIEF SUMMARY

Non-limiting embodiments of the present disclosure relate to family of composite materials created using a materials design approach. According to one non-limiting embodiment, the composite materials comprise a hard particulate component, an additive component, and a binder component. The hard particulate component may be selected from the group consisting of tungsten carbide, ditungsten carbide, titanium carbide, crushed cemented carbide, rounded tungsten carbide-containing granules, silicon carbide, boron carbide, aluminum oxide, zirconium carbide, zirconium oxide, tantalum carbide, niobium carbide, hafnium carbide, chromium carbide, vanadium carbide, diamond, boron nitride, and combinations thereof. The binder component may be selected from the group consisting of a rubber, a polymer, an epoxy, a silicone, an elastomer and combinations thereof.

Other non-limiting embodiments provide for a hardfacing appliqué. The hardfacing appliqué comprises: from about 20% to about 90% by weight of a hard particulate selected from the group consisting of tungsten carbide, cemented carbide, titanium carbide, zirconium carbide, zirconium oxide, tantalum carbide, niobium carbide, hafnium carbide, chromium carbide, vanadium carbide, and combinations thereof; from about 0% to about 50% by weight of an additive comprising a transition metal-base braze alloy; and from about 1% to about 20% by weight of a fugitive binder.

Still other non-limiting embodiments provide for an extrudable abrasive putty. The extrudable abrasive putty comprises: from 0% up to about 98% by weight of a hard particulate; from 0% up to about 30% by weight of an additive; and about 2% to about 50% by weight of a binder. The hard particulate may be selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, and combinations thereof. The additive may be selected from the group consisting of titanium particles, a stabilizer, a colorant, an antioxidant, a hardener, and combinations thereof.

Further non-limiting embodiments provide for a skid-resistant sheet. The skid-resistant sheet may comprise: from 0% up to about 98% by weight of a hard particulate; from 0% up to about 98% by weight of an additive; and about 2% to about 50% by weight of a binder. The hard particulate may be selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, diamond, boron nitride, and combinations thereof. The additive may be selected from the group consisting of coarse tungsten particles, titanium particles, a stabilizer, a colorant, an antioxidant, and combinations thereof.

Still further non-limiting embodiments provide for a radiation shielding layer. The radiation shielding layer may comprise: from 0% up to about 98% by weight of an additive; and about 2% to about 50% by weight of a binder. The additive may be selected from the group consisting of tungsten powder, a stabilizer, a colorant, an antioxidant, and combinations thereof.

Still other non-limiting embodiments provide for a molded hard preform. The molded hard preform may comprise: from 0% up to about 98% by weight of a hard particulate; from 0% up to about 50% by weight of an additive; and about 2% to about 50% by weight of a binder.

Other non-limiting embodiments provide for a high radiographic density extrudable putty. The high radiographic density extrudable putty may comprise: about 50% to about 98% by weight of an additive; and about 2% to about 50% by weight of a binder. The additive may be selected from the group consisting of tungsten powder, a stabilizer, a colorant, an antioxidant, and combinations thereof.

Further non-limiting embodiments provide for a conformal abrasive sheet. The conformal abrasive sheet may comprise: from 0% up to about 98% by weight of a hard particulate; from 0% up to about 50% by weight of an additive; and about 2% to about 50% by weight of a binder. The hard particulate may be selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide,, diamond, boron nitride, and combinations thereof. The additive may be selected from the group consisting of coarse tungsten particles, titanium particles, a stabilizer, a colorant, an antioxidant, fibers, transition metal-base braze alloys, and combinations thereof.

Still further non-limiting embodiments provide for methods of forming a composite material. According to certain non-limiting embodiments, the method comprises: determining a maximum solids loading of the composite material by one of bimodal tailoring of the particle size distribution of at least one of the hard particulate component and the additive component, tri-modal tailoring of the particle size distribution of at least one of the hard particulate component and the additive component, and multi-modal tailoring of the particle size distribution of at least one of the hard particulate component and the additive component, wherein the composite material comprises a hard particulate component, an additive component and a binder component.

Another non-limiting embodiment provides for composite material comprising a hard particulate component; an additive component; and a binder component comprising at least one material selected from the group consisting of a rubber, a polymer, an epoxy, a silicone, and an elastomer, wherein the composite material has a form selected from the group consisting of a hardfacing appliqué, an extrudable abrasive putty, a high radiographic density extrudable putty, a conformal abrasive sheet, a skid-resistant sheet, a radiation shielding layer, and a molded hard preform.

### BRIEF DESCRIPTION OF THE DRAWINGS

The various non-limiting embodiments of the present disclosure may be better understood when read in conjunction with the following figures.

FIG. 1 illustrates a pseudo-ternary diagram of embodiments of compositions of the present disclosure, showing relative volume fractions of the various constituents.

FIGS. 2a and 2b show pliable putties containing 70% by volume of G-90 grade tungsten powder and 80% by volume of C-20 grade tungsten powder, respectively.

FIG. 3 illustrates the relationship between putty density and tungsten loading volume for pliable putties loaded with G-90 grade tungsten powder and C-20 grade tungsten powder.

FIGS. 4a-4d plot the weight loss rate of putties exposed to 100° C. as a function of time for G-90 grade tungsten loaded putties (FIGS. 4a and 4b) and C-20 grade tungsten loaded putties (FIGS. 4c and 4d).

FIGS. 5a and 5b plot weight loss of putties exposed to UV radiation as a function of time for G-90 grade tungsten loaded putties (FIGS. 5a) and C-20 grade tungsten loaded putties (FIGS. 5b).

FIGS. 6a and 6b plot weight loss of putties immersed in water as a function of time for G-90 grade tungsten loaded putties (FIGS. 6a) and C-20 grade tungsten loaded putties (FIGS. 6b).

### DETAILED DESCRIPTION

Certain non-limiting embodiments of the present disclosure relate to new composite materials comprising a hard particulate component; an additive component; and a binder or carrier component. The composite materials represent a family of composite materials targeting specific applications through a materials design approach. The family of composite materials described herein may contain, for example, a dense packing of particles (hard particulates and/or additive particles) dispersed within an organic or silicon binder/carrier, which have a wide variety of uses in applications requiring important material characteristics, such as, for example, wear resistance, abrasiveness, surface friction, and/or density. According to certain non-limiting embodiments, the composite material may be one of a flexible conformal sheet, a rigid machinable preform and an extrudable putty. Other non-limiting embodiments relate to methods of manufacture of the composite materials described herein.

Other than the operating examples, or where otherwise indicated, all numbers expressing quantities of ingredients, processing conditions and the like used in the specification and claims are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical values, however, inherently contain certain errors, such as, for example, equipment and/or operator error, necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of less than or equal to 10.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

One concept underlying certain non-limiting embodiments of the present disclosure is the design of composite materials comprising a dispersion of a hard particulate component within an organic or silicone carrier or binder. The properties of the hard particulate component and the carrier/binder may be varied to suit specific applications. The properties of the carrier/binder may be chosen so as to provide a wide range of characteristics, such as, for example, composite strength, toughness, hardness, abrasiveness, and thermochemical behavior. Size distribution and degree of loading of the hard particulate component may also be varied to achieve desired characteristics. Further, according to various non-limiting embodiments, an important third functional category comprises an additive component that may impart additional characteristics, such as, for example, modified hardness or density, compositional adjustment, and/or specific chemical and/or physical attributes. Thus, according to various non-limiting embodiments, the present disclosure contemplates composite materials comprising a hard particulate component; an additive component; and a binder component.

Various non-limiting embodiments of the present disclosure provide for a family of composite materials that can be optimized to address a variety of common industrial and other applications. Certain non-limiting embodiments of composite materials are based on the creation of materials comprising a dense packing of a hard particulate component and an additive component within an organic or silicone carrier or binder which may have a wide variety of uses in applications requiring wear resistance, surface friction, and/or density as important material characteristics. As used herein, the terms “binder,” “carrier,” and “matrix” are substantially synonymous and defined as a continuous or principal phase or medium in which at least one other constituent is embedded or dispersed.

According to certain non-limiting embodiments, the additive component of the composite may be added to enhance various desired characteristics of interest for the composite for a given application. For example according to certain embodiments, the additive may be added to promote easier processing; for minimization of flow separation; for promotion of chemical stability for a given environment, particularly in non-thermal applications; for coloration and identification purposes; to promote adhesion of the hard particulate component to a surface, such as by brazing; for reinforcement purposes; for anti-oxidation purposes; and various combinations of the foregoing.

The optimization of the various characteristics of the composite of the non-limiting embodiments of the present disclosure may also be accomplished for a given application by varying other factors beyond the nature of the hard particulate, the additive, and/or the binder, such as, for example, percentage of hard particulate component and/or additive loading; variation of carrier chemistry, such as degree of polymerization or cross-linking; alteration of particle size distribution of the hard particulate component and/or additive component; and variation of the ratio of the hard particulate component to the other solid additives.

Various non-limiting embodiments of the composite materials of the present disclosure may be classified into three general categories of composite materials: molded preform shapes; conformal sheets; and extrudable putties.

Molded preform shapes are typically monolithic shapes, such as, for example, blocks, plates, hollow cylinders, solid rods, spheres, disks, and other bulk shapes, containing high solids loading for optimized wear resistance, hard particulate component content, and/or maximized packing density. Molded preforms may be molded in a shape substantially the same as the shape desired for the ultimate end use, or, alternatively, may be machined during post-molding processing to the desired shape. For molded preform shapes to be used for non-thermal applications, the carrier composition and volume fraction of particulate loading may be chosen to provide various combinations of desired characteristics, such as, toughness, hardness, and machinability.

Conformal sheets are typically flexible, relatively thin, and easily trimmed to shape. As will be described in greater detail, one non-limiting embodiment of the conformal sheet may be used for a hardfacing appliqué, for example, with a burnable or chemically fugitive carrier and an additive component comprising a transition metal-base braze alloy. As used herein, the term “fugitive carrier” means a carrier component that may be removed by heating and/or contacting with a chemical during processing or use of the composite, such that removal of the fugitive carrier results in either removal of substantially all of the carrier or results in a remaining residue. In other non-limiting embodiments, the conformal sheet may also be used in a compounded form with a retained carrier, which may be used as a friction material, a skid-resistant sheet, an abrasive sheet, or a radiation shielding layer. As used herein, the term “retained carrier” means a carrier component that remains substantially intact or is substantially retained during processing and post-processing use of the composite material. According to certain non-limiting embodiments, a surface of the sheet to be used in applications may be designed to be adhesively bonded to another surface, for example, using standard industrial adhesives or other adhesive means known in the art.

The extrudable putties of the present disclosure are composite materials offering “caulk-like” consistency. According to certain non-limiting embodiments, the putty may be formulated to be manually moldable to a given substrate geometry. The putties are typically extrudable under relatively low pressure, such as, for example, less than 689.5 kPa (100 psi), although putties extrudable under higher pressures are also contemplated. In certain non-limiting embodiments, the putties may have the ability to cure to a higher viscosity upon extended exposure to air, sunlight, and/or heat via, for example, solvent evaporation, chemical reaction, polymerization, or other mechanisms. In other non-limiting embodiments, the putties may retain some or substantially all of their initial pliability over an extended period of time. Still other non-limiting embodiments of the putty compositions may be designed for thermal bonding with a burnable fugitive carrier, which may also contain additives for enhanced brazing response. According to a further non-limiting embodiment, the putty formulation may be of relatively high viscosity and exhibit good resistance to particle-carrier separation such that the putty is suitable for use as a “liquid abrasive” on surfaces via extrusion or other methods of dynamic flow contact. According to another non-limiting embodiment, the putties may act as an extrudable radiation shielding putty that may be manually applied, for example, to highly contoured or complex surfaces or cracks, for minimization of radiation “hot spots”. As used herein, the term “hot spots” means a part, region, or portion of the surface of a material that exhibits a higher radiation count than the surrounding material due to, for example, a crack or break in the surface or structure of a material through which radiation may pass.

Techniques for the compounding of particulate fillers into a carrier, such as various polymers, elastomers, silicones, and castable epoxies and urethanes are known to those skilled in the art. The composite materials of the present disclosure may utilize these known material processing techniques to create a new family of materials through a matrix-based approach to the formulation of the composite. According to various non-limiting embodiments of the present disclosure, a variety of carriers/binders, such as, for example, organic carriers/binders and silicone carrier/binders, may be employed to assist in varying the mechanical properties of the composite materials, for example, from tough and rigid composites to soft and readily pliable composites. This applications based materials design approach comprises selecting components from three functionally defined component groups: primary hard constituent particles; a carrier or binder that may be either retained or fugitive; and additive components that may serve additional functions, such as, for example, as a processing aid, composition modification, stabilization, reinforcement, and other functions within the composite.

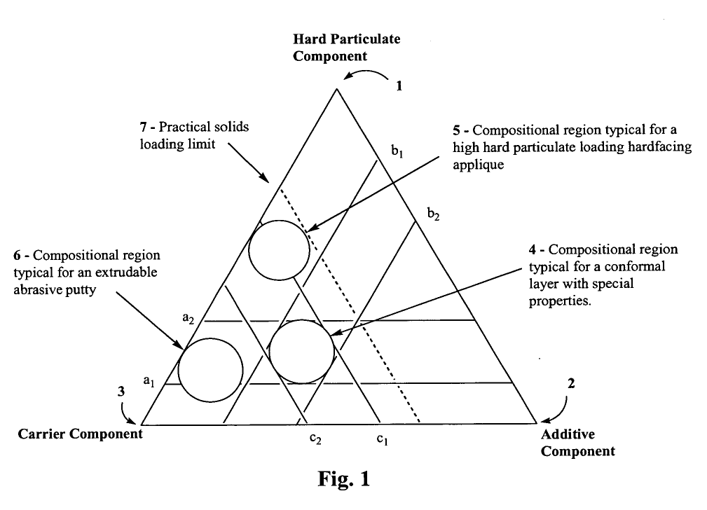

Referring now to FIG. 1, the pseudo-ternary diagram illustrates schematically the relative volume fractions of the various constituents of certain embodiments of the composite materials of the present disclosure. The 2-dimensional space defined by the pseudo-ternary diagram of FIG. 1 describes the complete set of compositions obtainable from the mixing of the components (i.e., the hard particulate component(s), the additive component(s), and the carrier component(s)). Further, such a data display may be constructed on a weight fraction or volume fraction basis. Each point in the defined space will have a composition coordinate (a, b, c), where, for example, “a” is the percentage of the hard particulate component(s), “b” is the percentage of the additive component(s), and “c” is the percentage of the carrier component(s). Each of the three corners of the equilateral triangle corresponds to a pure substance or, in the case of this pseudo-ternary diagram, a group of substances (such as, for example, a group of additive components, a group of carrier components, and/or a group of hard particulate components) as noted at the given corner of FIG. 1. Thus, for example, corner 1 of the triangle corresponds to the hard particulate component(s) [i.e., the point (100,0,0)], corner 2 of the triangle corresponds to the additive component(s) [i.e., the point (0,100,0)], and corner 3 of the triangle corresponds to the carrier component(s) [i.e., the point (0,0,100)]. The position of specific combinations or regions may thereby be defined quantitatively and displayed in relation to each other.

The compositional space defined in FIG. 1 illustrates that for a given particulate/additive/carrier system, there exists a maximum practical solids loading (hard particulate plus additive), shown by the dashed line 7 in FIG. 1, beyond which a higher loading of hard particulates and additives may result in incomplete particle-carrier wetting. While the existence of a solids loading limit is represented by this dotted line, one skilled in the art would recognize that within a multi-component system, such as in certain non-limiting embodiments described herein, the solids loading limit boundary may not be a straight line but, rather, may be a more complex curve. Further, as FIG. 1 is for generic description only, with no actual substances represented, its layout is understood to be qualitative in nature and not quantitative in nature. Quantification of the diagram and its composite design space is possible when real material systems are presented. In certain embodiments, when this loading threshold is exceeded, both formability and uniformity of the composite materials may be adversely affected. Thus, those non-limiting embodiments for uses sensitive to such factors must comprise loading combinations below this critical value for the components chosen. For other non-limiting embodiments, exceeding the critical solids loading may not be detrimental, for example, for applications such as conformal hardfacing appliqués, as described below. In these cases, adequate handling integrity must still be preserved for the particular application.

FIG. 1 further illustrates how the ratio of hard particulate component(s) to additive component(s) can be continuously varied at a given solids loading to target the properties needed for a specific application. Certain regions within the diagram may be typical for specific non-limiting composition or application. For example, region 4 may be typical for certain non-limiting embodiments of a conformal layer or sheet according to the present disclosure, wherein the embodiments of the conformal layer or sheet within the region will have a hard constituent component(s) percent from a₁ to a₂, an additive component(s) percent from b₁ to b₂, and a carrier component(s) percent from c₁ to c₂. Other regions within the diagram may be typical for certain other non-limiting embodiments of compositions or applications. For example, region 5 may correspond to the compositional region typical for certain non-limiting embodiments of a hardfacing appliqué having a high loading of the hard particulate component and region 6 may correspond to a compositional region typical for certain non-limiting embodiments of an extrudable abrasive putty according to the present disclosure. It should be noted that other non-limiting embodiments of the conformal layer, hardfacing appliqué and/or abrasive putty may have compositions outside regions 4, 5, and/or 6, respectively.

According to the non-limiting embodiments of the present disclosure, FIG. 1 may be utilized to determine the appropriate loading of hard particulate(s) and additive(s) for a particular carrier.

Specific non-limiting embodiments of the various composite materials contemplated by the present disclosure will now be discussed in greater detail. The composite materials of the present disclosure comprise at least one hard particulate component; at least one additive component; and a binder or carrier component.

According to various non-limiting embodiments of the composite materials, the hard particulate component may be selected from the group consisting of tungsten carbide, ditungsten carbide, titanium carbide, crushed cemented carbide, rounded tungsten carbide-containing granules, silicon carbide, boron carbide, aluminum oxide, zirconium carbide, zirconium oxide, tantalum carbide, niobium carbide, hafnium carbide, chromium carbide, vanadium carbide, diamond, and boron nitride. According to certain non-limiting embodiments, the composite materials may comprise more than one type of hard particulate. For example, according to certain non-limiting embodiments, the composite materials may include two or more hard particulate materials selected from the group consisting of tungsten carbide, ditungsten carbide, titanium carbide, crushed cemented carbide, rounded tungsten carbide-containing granules, silicon carbide, boron carbide, aluminum oxide, zirconium carbide, zirconium oxide, tantalum carbide, niobium carbide, hafnium carbide, chromium carbide, vanadium carbide, diamond, and boron nitride. The average size of the particles of the hard particulate component is dependent on the specific application for the composite materials, as discussed below, and, as an example, may range from about 2 microns to about 10,000 microns.

According to certain non-limiting embodiments of the composite materials, the additive component may be selected from the group consisting of a metal, a transition metal-base braze alloy, an inorganic property modifier, a processing aid, an antioxidant, a colorant, a brazing flux, a stabilizer, a hardener, a surface modifier, a material capable of reducing flow separation of ingredients of the composite materials, a material capable of promoting chemical stability of the composite materials, a material that modifies at least one mechanical property of the composite materials, a reinforcing material, and various combinations thereof. In certain embodiments, the composite materials may comprise more than one additive, such as, for example, two or more additives selected from the group consisting of a metal, a transition metal-base braze alloy, an inorganic property modifier, a processing aid, an antioxidant, a colorant, a brazing flux, a stabilizer, a hardener, a material capable of reducing flow separation of ingredients of the composite materials, a material capable of promoting chemical stability of the composite materials, a material that modifies at least one mechanical property of the composite materials, and a reinforcing material.

In certain non-limiting embodiments where the additive component comprises at least one metal, the at least one metal may be selected from the group consisting of tungsten, titanium, molybdenum, chromium, nickel, iron cobalt, copper, tin, bismuth, zinc, silver, and combinations thereof. The at least one metal may be a particulate or powder having an average particle size of about 0.1 microns to about 1000 microns. For example, the at least one metal may be a fine particulate, such as, for example, a powder having an average particle size of about 0.1 microns to about 3 microns. Alternatively, in certain other non-limiting embodiments, the metal may be in the form of a medium-size particulate having an average particle size of about 3 microns to about 10 microns, or a coarse particulate having an average particle size of about 10 microns to about 1000 microns. According to certain non-limiting embodiments, the at least one metal may be chosen from tungsten or titanium.

In certain non-limiting embodiments, the additive may comprise at least one transition metal-base braze alloy or welding alloy. In certain non-limiting embodiments comprising at least one braze alloy, the additive may further comprise a flux or a fluxing agent. Alternatively, in certain embodiments the binder may comprise a fugitive binder, wherein removal or burnout of the fugitive binder results in a residue that is a flux or a fluxing agent. Thus, in certain embodiments of the composite materials of the present disclosure comprising a transition metal-base braze alloy as an additive, heating of the composite materials may result in welding or otherwise bonding of the composite materials to a surface, for example by brazing of the transition metal-base braze alloy. The heating of the composite material may be from a heat source, such as, for example, a flame, thermal heat, an electrical plasma, a laser, an arc light, and/or a high intensity incandescent light, or, alternatively, the heating may be from friction, for example, kinetic or thermal friction during use of the composite material. In certain embodiments, the brazing of the composite materials may be promoted by the presence of the flux or fluxing agent, either as an additional additive component or as a residue from burnout of a fugitive carrier during the brazing process. In those non-limiting embodiments where the additive comprises at least one transition metal-base braze alloy, the braze alloy may be, for example, one or more selected from the group consisting of a copper-base braze alloy, a nickel-base braze alloy, a cobalt-base braze alloy, a silver-base braze alloy, a Ni—Co base braze alloy, a Ni—Cu base braze alloy, a titanium alloy, and combinations thereof.

In certain non-limiting embodiments, the additive may comprise at least one inorganic property modifier, such as, for example, a metal oxide powder (titanium oxide, aluminum oxide, and the like), a carbonate, a silicate, a hydrate, glass beads, a phosphate, a borate or other flame retardant material, a magnesium salt, and a small particle size metal (as set forth herein), such as a fine metal for use, for example, as an antistatic surface. Additive-induced property modification may also be made for the purpose of altering thermal conductivity, mechanical properties, and/or electromagnetic permeability. According to other non-limiting embodiments, the additive may comprise at least one processing aid (such as, for example, a surfactant or a lubricant, which may be, for example, a metallic stearate or a petroleum wax), a curing agent (which may be peroxide based or another radical initiator), a filler-binder couplant, and a mold release agent. According to further non-limiting embodiments, the additive may comprise at least one colorant, for example, an organic dye, a metal oxide powder, an inorganic colorant, and carbon black. The additive may also comprise an antioxidant or UV stabilizer, such as, for example, one of the various proprietary formulations available to the plastics industry that are designed to be compatible with the chemistry of the specific carriers used in a particular embodiment. It is further contemplated that the additive component may comprise various combinations of the above-listed additive components as necessary to provide the desired characteristics.

The binder/carrier used in the various embodiments of the composite materials of the present disclosure will now be discussed in detail. In certain non-limiting embodiments, the composite materials comprise a binder that includes at least one material selected from the group consisting of a rubber, a polymer, an epoxy, a silicone, and an elastomer. In other non-limiting embodiments, the binder comprises two or more materials selected from the group consisting of rubbers, polymers, epoxies, silicones, and elastomers. When the binder comprises a rubber, rubbers suitable for use in these embodiments include, but are not limited to, natural isoprenes, latex, chloroprene, styrene, butadienenitriles, butyls, neoprenes, urethanes, fluoroelastomers, and mixtures thereof. In those embodiments where the binder comprises a polymer, suitable polymers include, but are not limited to, acetal co-polymers, acetal homopolymers, acrylics, acrylonitrile butadiene styrene (“ABS”), celluloses, polyamides such as nylons and polyarylamides, polyimides, polycarbonates, polybutylene terephthalates, PEEK™(polyetheretherketone, a trademark of Victrex pic, of Lancashire, England), polyethyleneimine (“PEI”), polyethersulfone (“PES”), polyolefins, polyesters, polystyrene, polyphenylene oxide (“PPO”), polysulfone, polyvinyl chloride (“PVC”), thermoplastics, polyurethanes, epoxies, phenolics, vinyl esters, urethane hybrids, and mixtures thereof.

According to certain non-limiting embodiments, the binder may be a retained binder, as defined herein. In other non-limiting embodiments the binder may be a fugitive binder, as defined herein, such as, for example, a binder that is at least substantially removed by at least one of heating and contacting with a chemical during the process of applying the composite materials to a surface or article, or during the process of using the composite materials. In various embodiments where the fugitive binder is removed during the application or use of the composite materials by heating, the heating may be the result of, for example, at least one of friction, a flame, electrical plasma, a laser, a wide area radiant arc light, and a wide area radiant high intensity incandescent light. In certain embodiments where the fugitive binder is removed by contacting with a chemical, the chemical removal of the binder may be via exposure to a reactive agent, which may, for example, cause dissolution, catalysis, or decomposition of the binder.

In various non-limiting embodiments wherein the binder is a fugitive binder, some or substantially all of the fugitive binder may be removed during the application or use of the composite materials. As used herein, removal of substantially all of the fugitive binder means removal of greater than 90% of the fugitive binder. Alternatively, in other non-limiting embodiments comprising a fugitive binder, removal of the binder may result in a residue, such as, in one non-limiting example, when a high char binder is used. For example, the residue from removal of the fugitive binder may be used to promote post-fusion composition control. The residue that results from removal of the fugitive binder according to certain embodiments may be a fluxing agent that provides a fluxing action during brazing of the composite materials to a substrate, such as, for example, when the additive comprises at least one transition metal-base braze alloy. In other non-limiting embodiments, the residue that results from removal of the fugitive binder may bond or adhere the hard particulates and additives to a substrate, such as, for example, a face of a rock crushing bit or a surface of a metalworking tool.

According to one non-limiting method for forming the various non-limiting composite materials of the present disclosure, the composite material may be formed by tailoring the particle size distribution of at least one of the particulate components to increase the maximum solids loading of the composite material. Those familiar with particulate materials will recognize that all bulk, commercially available powders are comprised of a size distribution of individual particles. Various instrumental techniques exist for characterizing the nature of this particle size distribution. Powders commonly exhibit a center-weighted distribution, similar to a “bell curve” profile, in which a population of coarser and finer particles coexists within the dominant “average” particle size by which a given powder may be denoted. Distributions may also be asymmetric, i.e., skewed toward finer particles or coarser particles. In all of these cases where a single, central distribution peak is present, the particle size distribution is said to be of “single mode”. According to certain non-limiting embodiments, the method may comprise a bimodal tailoring of the particle size distribution. According to another non-limiting embodiment, the method may comprise a tri-modal tailoring of the particle size distribution. According to another non-limiting embodiment, the method may comprise a multi-modal tailoring of the particle size distribution. As used herein, the terms “bimodal tailoring”, “tri-modal tailoring”, and “multi-modal tailoring” mean the calculated blending of two, three, or multiple powders, respectively, of the same composition but of distinctly different particle size distributions for the purpose of producing a wider size distribution than would be available from a single-mode powder lot. According to certain non-limiting embodiments, for properly formulated powder blends the correct population of smaller particles may fill in the spaces between the larger particles for an increased solids loading and,.hence, a greater composite density. Certain non-limiting embodiments of the composite material of the present disclosure comprise: a hard particulate component; an additive component; and a binder component, wherein the maximum solids loading of the composite material is increased by use of one of a bimodal tailoring of the particle size distribution of at least one of the hard particulate component and the additive component, a tri-modal tailoring of the particle size distribution of at least one of the hard particulate component and the additive component, and a multi-modal tailoring of the particle size distribution of at least one of the hard particulate component and the additive component.

Various non-limiting embodiments of applications for the composite materials of the present disclosure will now be discussed in detail. According to certain non-limiting embodiments, the composite materials may be a molded preform, such as a molded hard preform. The preform of these embodiments may be molded into the desired final shape or, alternatively, may be machinable (post-molding) to achieve the desired final shape. A molded preform may be made by a process comprising, for example, one or more conventional molding technique, such as, for example, compression molding, injection molding, powder injection molding, and injection-compression molding. According to certain embodiments, the composite materials may have the form of pellets, such that the pellets can be combined, for example, under heat and/or pressure, such as by compression molding, to form the molded hard preforms. Certain non-limiting embodiments of the molded preforms of the present disclosure may comprise a hard particulate component comprising tungsten carbide particles and/or titanium carbide particles, wherein the particles have an average particle size of about 2 microns to about 10 microns. Certain non-limiting embodiments of the molded preforms may comprise an additive comprising a metal powder, such as, for example, a tungsten powder. For example, the powder may be added in an amount sufficient to limit the abrasiveness of the hard particulate components to a desired level. Alternatively, the powder (for example, tungsten powder) may be added in an amount sufficient to provide a desired density for the molded preform, such as, for example, a density roughly comparable to that of metallic lead, i.e., in the range of about 7 g/cm³ to about 12 g/cm³. The preforms of these non-limiting embodiments may be molded in a shape similar to the desired article or, alternatively, may have a general shape that may be machined to the desired shape, for example, the preform may have a molded shape of a block, a plate, a hollow cylinder, a solid rod or cylinder, a sphere, or a disk. Molded preforms will typically be of high strength and, therefore, binders will generally be chosen from polymeric materials having high strength and rigidity.

With regard to the loading limits of the solid particles, including the hard constituent particles and additive particles, such as, for example metal powders for certain embodiments of the molded preforms, the lower limit of total solid particle loading may be determined by the minimal amount of dispersed solid phase needed to yield a composite material that is functional for the specified application. The upper loading limit may be defined by many factors, including, but not limited to, the particle size distribution of each solid particle component (e.g., hard particulate and additive particulate), particle shape, the relative “wettability” provided by a given binder/carrier, the allowable presence of certain processing aids, such as surfactants, and the mixing and/or shaping practice. These upper and lower limits will define the practical limit of solids loading. A further increase in solids loading will result in incomplete particle wetting, which can result in flow separation during shaping (i.e., molding). Referring to FIG. 1, the practical loading limits for solid hard particulates and additives for a certain composite composition may be represented by the dotted line 7 marked “practical solids loading limit”.

According to certain non-limiting embodiments of the composite materials of the present disclosure, the molded preform may be a molded hard preform comprising from 0% up to about 98% by weight of a hard particulate; from 0% up to about 50% by weight of an additive; and about 2% to about 50% by weight of a binder. Other non-limiting embodiments of the molded hard preform may comprise from about 0.1% to about 98% by weight of the hard particulate; from 0.1% up to about 50% by weight of an additive; and about 2% to about 50% by weight of the binder. According to certain non-limiting embodiments, the molded preform may comprise a hard particulate comprising tungsten carbide and/or titanium carbide having an average particle size of 2 microns to 10 microns, and the additive may comprise tungsten powder and/or titanium powder. In certain non-limiting embodiments, the preform may be formed by the process of powder injection molding. The preform may have a shape, such as a block, a plate, a hollow cylinder, a solid rod, a sphere, or a disk, which may be machined to a final shape after forming of the preform by powder injection molding. Alternatively, the molded preform may have a shape substantially near that of the final shape.

Lead in the environment, such as lead from spent munitions, such as bullets, may lead to accumulations of lead in soil, wetlands, bodies of water, and/or ground water. Minimization or reduction of lead levels may be possible by the use of low-lead or lead-free ammunition. In certain embodiments of the preform, wherein the additive comprises tungsten powder, the tungsten powder additive may be added in an amount sufficient to make the density of the preform from about 9 g/cm³ to about 12 g/cm³. Preforms with densities within this range mimic the densities of lead, without having certain detrimental environmental drawbacks of articles manufactured from lead, such as various types of ammunition and projectiles. Non-limiting examples of hard preforms within the scope of the present disclosure include cylindrical preforms having a diameter of about 0.56 cm (0.22 inches) to about 1.3 cm (0.5 inches) and a length of about 1.3 cm (0.5 inches) to about 6.35 cm (2.5 inches). Preforms according to these embodiments may be used as a lead-free bullet or certain other types of projectile munitions.

According to other non-limiting embodiments, the composite materials of the present disclosure may comprise a conformal sheet. As used herein, the term “conformal sheet” refers to a material that is thin relative to its length and width, having the capability to conform to the general shape and contour of a surface of an article. Non-limiting embodiments of the composite materials in the form of a conformal sheet include, but are not limited to, a hardfacing appliqué, an abrasion resistant layer or sheet, a friction material, an abrasive sheet, and a flexible radiation shielding layer. The composite materials in the form of a conformal sheet or layer may be adapted to be adhered to the surface of a substrate, for example, with a commercially available adhesive or by welding, such as, for example, via at least one of the additive components comprising a transition metal-base braze alloy.

In certain non-limiting embodiments, the composite materials may be provided in the form of a conformal sheet that is a hardfacing appliqué. According to various embodiments, the hardfacing appliqué may comprise a hard particulate, which in one non-limiting example may comprise at least one of coarse grain tungsten carbide, titanium carbide, zirconium carbide, zirconium oxide, tantalum carbide, niobium carbide, hafnium carbide, chromium carbide, vanadium carbide, and crushed cemented carbide, having an average particle size of about 5 microns to about 10,000 microns. Certain non-limiting embodiments of the hardfacing appliqué may additionally comprise an additive component comprising a transition metal-base braze alloy, such as, for example, a copper-base braze alloy, a nickel-base braze alloy, a cobalt-base braze alloy, a silver-base braze alloy, a titanium alloy, a Ni—Co base braze alloy, or a Ni—Cu base braze alloy. Other braze alloys or welding alloys, including those meeting the standards of the American Welding Society (“AWS”), may also be used. The binder in certain embodiments of hardfacing appliqué composite materials according to the present disclosure may comprise a fugitive binder, as described herein. The hardfacing appliqué, which may comprise the hard particulate and the additive upon removal of the binder, may be bonded to at least a portion of the surface of a substrate, for example, by welding or brazing via the transition metal-base braze alloy. According to certain non-limiting embodiments, the substrate may be, for example, an industrial tool, such as a rock crushing tool or a metalworking tool.

According to certain non-limiting embodiments, the hardfacing appliqué may comprise from about 20% to about 97% by weight of a hard particulate, such as tungsten carbide, titanium carbide, cemented carbide, zirconium carbide, zirconium oxide, tantalum carbide, niobium carbide, hafnium carbide, chromium carbide, vanadium carbide, and combinations thereof; from about 1% to about 20% by weight of an additive comprising a transition metal-base braze alloy, such as, those described herein; and from about 0% to about 50% by weight of a fugitive binder. In other embodiments, the fugitive binder may comprise from about 0.1% to about 50% of the weight of the appliqué.

In non-limiting examples of hardfacing appliqués of the present disclosure, the fugitive binder may be removed after applying the appliqué to a surface by heating the appliqué and/or surface, such as, for example, using one or more of a flame, electrical plasma, a laser, a wide area radiant arc light, a wide area radiant high intensity incandescent light, or by thermal friction. In certain embodiments, substantially all of the fugitive binder may be removed. In other non-limiting embodiments, the removal of the fugitive binder results in a residue, wherein the residue comprises a fluxing agent. In other non-limiting embodiments of the hardfacing appliqués, the additive may comprise a fluxing agent.

In another non-limiting embodiment wherein the composite materials comprise a conformal sheet, the conformal sheet may comprise a radiation shielding layer. In these embodiments, the composite materials may include a powdered material such as, for example, a tungsten powder, in an amount sufficient to provide the necessary absorption of radiation. For example, the conformal sheet may include an amount of a powder having a thermal neutron capture cross section of at least 1,000 barns. In certain embodiments, a tungsten powder may be added in an amount sufficient to give the composition a density of about 7 g/cm³ to about 12 g/cm³. In yet other non-limiting embodiments, a tungsten powder may be added in an amount sufficient to give the conformal sheet a density of about 8 g/cm³ to about 11 g/cm³. In still other non-limiting embodiments, a tungsten powder is added in an amount sufficient to give the conformal sheet a density of about 7 g/cm³ to about 10 g/cm³. The radiation shielding layer may be flexible and adapted to be adhered to a surface, for example, with an adhesive, such as an industrial adhesive. Alternatively, the radiation shielding layer may be a rigid or semi-rigid plate or sheet. Certain non-limiting embodiments of the radiation shielding layer may have a thickness of about 0.20 cm (0.08 inch) to about 0.76 cm (0.3 inch). Alternatively, the shielding layer may have a thickness of about 0.13 cm (0.050 inch) to about 0.38 cm (0.150 inch). The radiation shielding layer may further comprise, for example, additives such as stabilizers (e.g., UV stabilizers), colorants, antioxidants, and other additives as described herein.

Certain non-limiting embodiments of the radiation shielding layer comprise from 0% up to about 98% by weight of an additive selected from the group consisting of tungsten powder, a stabilizer (for example a UV stabilizer), a colorant, an antioxidant, and combinations thereof; and about 2% to about 50% by weight of a binder. Other non-limiting embodiments may comprise from 0.1% up to about 98% by weight of an additive; and about 2% to about 50% by weight of a binder. In certain non-limiting embodiments of the shielding layer, the weight percentage of the hard particulate component may be from 0% to about 1% by weight. Other embodiments may comprise from about 0.1% to about 1% by weight of the hard particulate. The binder of the radiation shielding layer may comprise, for example, a high strength, tough polymer, such as, for example, acetal co-polymers, acetal homopolymers, acrylics, celluloses, polyamides, polyimides, polybutylene terephthalate, PEEK, PEI, PES, polyolefins, polyesters, polystyrene, PPO, polysulfone, PVC, thermoplastics, polyurethanes, epoxides, phenolics, vinyl esters, urethane hybrids, polycarbonates, ABS, and combinations thereof.

In still another non-limiting embodiment wherein the composite materials of the present disclosure comprises a conformal sheet, the conformal sheet may comprise a skid-resistant sheet, a friction material, and/or an abrasive sheet, each of which may be adapted to be applied to a surface. Certain embodiments of the conformal sheet may be adapted to be adhesively bonded to a surface, for example, using a commercially available adhesive. Where the composite materials are in the form of a skid-resistant sheet, a friction material, and/or an abrasive sheet, the composite materials may comprise, for example, a hard particulate comprising at least one of tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, diamond, boron nitride, and combinations thereof, having an average particle size of about 5 microns to about 5,000 microns.

The additive component in composite materials comprising a skid-resistant sheet, a friction material, and/or an abrasive sheet may comprise, for example, coarse grain tungsten and/or titanium particles which may have an average particle size of about 40 microns to about 10,000 microns. Alternatively, or in addition to the metal particles, the additive may comprise one or more of antioxidants, stabilizers, reinforcing fibers, and colorants. Reinforcing fibers suitable for use as at least one additive in the various non-limiting embodiments of the composite materials disclosed herein including, but not limited to, abrasive sheets, skid-resistant sheets, and friction materials, may comprise textile fibers, metal fibers, glass fibers, cellulose fibers, and combinations thereof. The fiber additives may serve to reinforce the sheet and/or reduce glazing or loading during use. The fibers may be oriented within the composite materials in a variety of ways within the sheet, such as, for example, as a woven network, as an oriented loose fiber network, or as a randomly oriented fiber network.

Various non-limiting embodiments of a skid-resistant sheet or a friction material may comprise from 0% up to about 98% by weight of a hard particulate selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, diamond, boron nitride, and combinations thereof; from 0% up to about 98% by weight of an additive selected from the group consisting of coarse tungsten particles, titanium particles, a stabilizer, a colorant and an antioxidant; and about 2% to about 50% by weight of a binder. In other non-limiting embodiments, the skid-resistant sheet or friction material may comprise from 0.1% up to about 98% by weight of the hard particulate; from 0.1% up to about 98% by weight of the additive; and about 2% to about 50% by weight of the binder. In certain embodiments, the skid-resistant sheet or the friction material may have a thickness of about 0.076 cm (0.03 inch) to about 0.25 cm (0.10 inch). Certain non-limiting embodiments of the skid-resistant sheet or the friction material may be adapted to be adhered to at least a portion of a surface of a substrate. For example, in certain embodiments, the skid-resistant sheet or friction material may be adapted to be adhered with an adhesive, such as an industrial adhesive. In other non-limiting embodiments the skid-resistant sheet or friction material comprises a fugitive binder, wherein removal of the fugitive binder by application of heat or contact with chemicals, as discussed herein, may result in a residue wherein the residue comprises an adhesive. In these embodiments, the adhesive residue from removal of the binder may bind the hard particulate and additive to the surface of a substrate.

In other non-limiting embodiments wherein the composite materials is a conformal abrasive sheet, the sheet may comprise: from 0% up to about 98% by weight of a hard particulate selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, diamond, boron nitride, and combinations thereof; from 0% up to about 50% by weight of an additive selected from the group consisting of coarse tungsten particles, a stabilizer, a colorant, an antioxidant, fibers, transition metal base braze alloys, and combinations thereof; and about 2% to about 50% by weight of a binder. In other embodiments, the conformal abrasive sheet may comprise from about 0.1% up to about 98% by weight of the hard particulate; from about 0.1% up to about 50% by weight of the additive; and about 2% to about 50% by weight of the binder. The binder, according to certain non-limiting embodiments, may comprise an elastomer or a urethane. The abrasive sheet may be formulated for controlled wear such that in response to abrasion, the sheet continually will expose new abrasive grains on the surface as old grains on the surface layer are abraded off.

In a further non-limiting embodiment, the composite materials of the present disclosure may comprise an extrudable putty. The extrudable putty, for example, may be an abrasive putty or a putty having a high radiographic density suitable for use as a radiation shielding putty. According to certain non-limiting embodiments, the putty is extrudable under low pressure, for example, under an applied pressure of less than 689.5 kPA (100 psi). In certain non-limiting embodiments, the extrudable putty composite materials may comprise a hard particulate, such as those described herein, having an average particle size of about 2 microns to about 5 microns. In other embodiments, the extrudable putty may comprise a binder comprising silicone and an additive comprising tungsten powder, in an amount sufficient to give the putty a density of greater than about 7 g/cm³, preferably from about 7 g/cm³ to about 12 g/cm³.

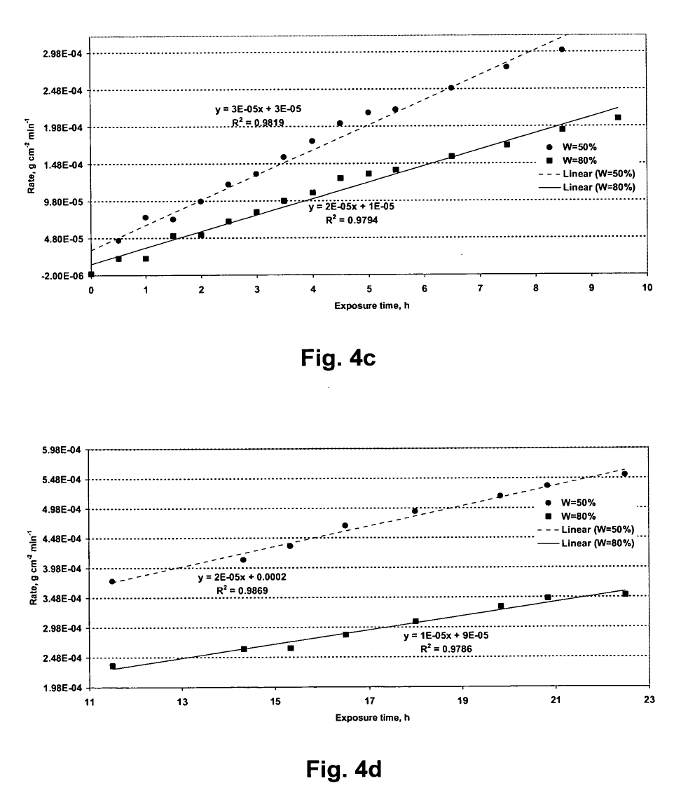

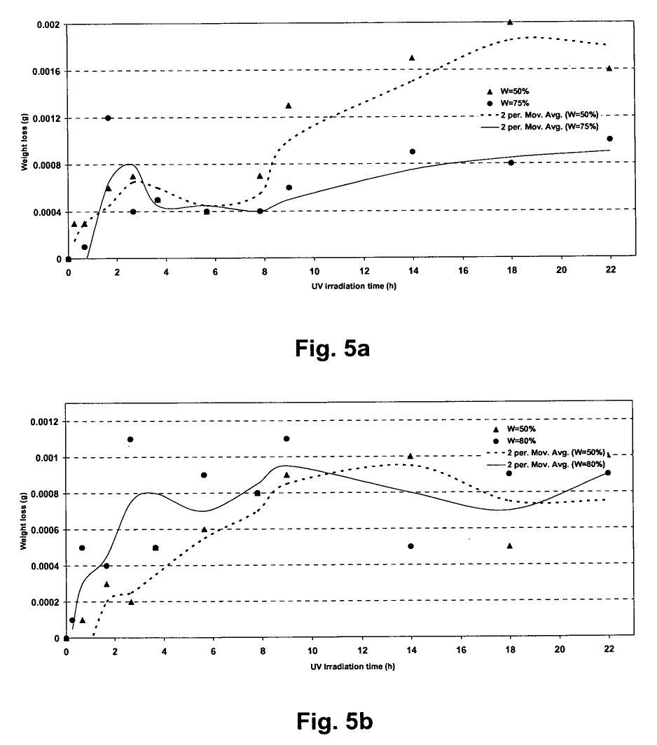

In those non-limiting embodiments of an extrudable putty that comprise tungsten as an additive, the putty may have a high radiographic density, such that it may be used as a pliable radiation shielding putty which can be extruded onto irregular or highly contoured surfaces and cracks to cover radiation “hot spots”. According to certain non-limiting embodiments, the putty may comprise a solvent and may be curable to a higher viscosity by evaporation of the solvent, chemical reaction, and/or polymerization. Non-limiting examples of high radiographic density extrudable putties of the present disclosure comprise: about 50% to about 98% by weight of an additive selected from the group consisting of tungsten powder, a stabilizer, a colorant, an antioxidant, transition metal-base braze alloys, and combinations thereof; and about 2% to about 50% by weight of a binder. The high radiographic density putties would typically comprise relatively minor quantities of the hard particulate component, for example, from 0% to about 1% by weight. Other embodiments of the putties may comprise from about 0.1% to about 1% by weight of the hard particulate component. The binder of the certain embodiments of the high radiographic density putty may be an RTV silicone binder. In certain embodiments, the putty may remain pliable for an extended period of time or, alternatively, in other embodiments the putty may cure to higher viscosity, for example, via solvent evaporation, chemical reaction, and/or polymerization. As shown in FIGS. 4a-4d and 5a-5b, putties according to certain embodiments may demonstrate different rates of curing and/or loss of weight (for example, due to evaporation of solvent) which corresponds to a putty that remains pliable over time (lower rate and/or weight loss, as demonstrated by a low slope of the line) or a putty that cures to a higher viscosity over time (higher rate and/or weight loss, as demonstrated by a higher slope of the line). Various characteristics, such as, for example, curing rate or long term pliability, may be determined by loading amounts of the hard particulates and/or the additive(s) or the nature or design of the binder(s) (such as, for example, solvent volatility).

According to other non-limiting embodiments of the extrudable putty according to the present disclosure, the putty may comprise an abrasive putty. Non-limiting embodiments of abrasive putties according to the present disclosure may comprise from 0% up to about 98% by weight of a hard particulate selected from the group consisting of crushed sintered carbide, tungsten carbide, titanium carbide, silicon carbide, aluminum oxide, boron carbide, zirconium carbide, zirconium oxide, tantalum carbide, niobium carbide, hafnium carbide, chromium carbide, vanadium carbide, and combinations thereof; up to about 30% by weight of an additive selected from the group consisting of a stabilizer, a colorant, an antioxidant, and a hardener; and about 2% to about 50% by weight of a binder. Other non-limiting embodiments of the abrasive putty may comprise from 0.1% up to about 98% by weight of a hard particulate; from 0.1% up to about 30% by weight of an additive; and about 2% to about 50% by weight of a binder. Certain examples of the hard particulate component of the extrudable abrasive putty may have an average particle size of about 2 microns to about 100 microns. In certain non-limiting embodiments, the hard particulate may have an average particle size of about 3 microns to about 5 microns. The abrasive putties may comprise binders including hydrocarbon oils and greases, water soluble polymers, water-based emulsions, silicones, and low strength polymers.

Various embodiments of composite materials according to the present disclosure will now be illustrated in the following non-limiting examples. Those having ordinary skill in the relevant art will appreciate that various changes in the components, compositions, details, materials, and process parameters of the examples that are hereafter described and illustrated in order to explain the nature of the invention may be made by those skilled in the art, and all such modifications will remain within the principle and scope of the invention as expressed herein and in the appended claims. It will also be appreciated by those skilled in the art that changes could be made to the embodiments described above and below without departing from the broad inventive concept thereof. It is understood therefore, that this invention is not limited to the particular embodiments disclosed, but is intended to cover modifications that are within the principle and scope of the invention, as defined by the claims.

### EXAMPLES

### Example 1

Hardfacing Appliqué for Rock Crusher Faces

Hard particulate component: coarse grain tungsten carbide, titanium carbide, zirconium carbide, zirconium oxide, tantalum carbide, niobium carbide, hafnium carbide, chromium carbide, vanadium carbide, and/or crushed cemented carbide comprising from about 20% to about 97% by weight of the composite material and having average particle size of about 5 microns up to about 10,000 microns.

Carrier component: a fugitive polymer comprising about 1% to about 20% by weight and offering clean burnout during initial heat-up of the appliqué.

Additives: Copper-base braze alloy comprising about 0% to about 50% by weight.

The density of the appliqué preferably will be relatively high due to high loading of the hard particulate component, ranging from about 2 g/cm³ to about 10 g/cm³ and typically approaching or exceeding the calculated solids limit, as shown by dashed line 7 on FIG. 1. The form of the composite will be that of a thin plate that can be positioned on a surface of a rock crusher face, such as a worn surface, and subsequently bonded to that surface by thermal brazing of the braze alloy additive component, which may occur during thermal removal of the fugitive binder.

### Example 2

Preparation of Wear Surface on a Metalworking Tool

Hard particulate component: coarse grain tungsten carbide or titanium carbide comprising from about 20% to about 97% by weight of the composite material and having an average particle size of about 5 microns up to about 10,000 microns.

Carrier component: a fugitive elastomer comprising about 1% to about 20% by weight and offering clean burnout during initial heat-up of wear surface.

Additives: a transition metal-base braze alloy, such as a cobalt-, Ni—Co, or Ni—Cu base braze alloy or titanium alloy would be typical, but more expensive Ag-base brazes could also be used. The transition metal-base braze alloy would comprise from about 0% to about 50% by weight of the composite.

The density of the appliqué preferably will be relatively high due to high loading of the hard particulate component, ranging from about 2 g/cm³ to about 10 g/cm³ and typically approaching or exceeding the calculated solids limit, as shown by line 7 on FIG. 1. The form of the composite will be that of a flexible, trimmable conformal layer that can be positioned on the wear surface of the metalworking tool and subsequently bonded to that surface by thermal brazing of the braze alloy additive component, which may occur during thermal removal of the fugitive binder. It is envisioned that the composite will remain flexible for a defined storage time.

### Example 3

Extrudable, Abrasive Putty

Hard particulate component: medium grain tungsten carbide comprising from 0% up to about 98% by weight and having an average particle size of about 2 microns up to about 5 microns.

Carrier component: a polymer comprising from about 2% to about 50% by weight and providing a controlled and relatively constant viscosity.

Additives: stabilizers, such as UV stabilizers, and colorants for identification comprising from 0% up to about 30% by weight. Must be compatible with the specific carrier and would typically be readily available within the plastics industry.

The density of the putty preferably will be moderate, ranging from about 2 g/cm³ to about 8 g/cm³ due to the presence of the hard particulates. The putty will be preferably extrudable under low pressure, i.e., less than 689.5 kPa (100 psi), and resistant to flow separation. The putty also preferably will be non-corrosive, will have low toxicity, and will be readily recyclable.

### Example 4

Bondable Skid-resistant Sheet

Hard particulate component: medium grain crushed sintered carbide, zirconium carbide, zirconium oxide, tantalum carbide, niobium carbide, hafnium carbide, chromium carbide, vanadium carbide, or titanium carbide comprising from 0% up to about 98% by weight and having an average particle size of about 2 microns up to about 5 microns.

Carrier: a polymer comprising about 2% to about 50% by weight and providing high strength and toughness that is readily bondable using common adhesives.

Additives: coarse tungsten particles and/or titanium particles comprising from 0% up to about 98% by weight and having average particle size of about 5 microns up to 10,000 microns, along with antioxidants and stabilizers.

The density of the sheet preferably will be relatively high due to high loading of the hard particulate component ranging from about 2 g/cm³ to about 10 g/cm³. The form of the composite will be that of a semi-rigid, tear resistant sheet having a large surface area and a thickness typically in the range of 0.076 cm (0.03 inches) to 0.256 cm (0.10 inches). The sheet will be resistant to moisture, oxidation and UV degradation.

### Example 5

Radiation Shielding Layer

Hard particulate component: minimal, for example, from 0% to about 1% by weight.

Carrier: a polymer comprising about 2% to about 50% by weight and providing high strength and toughness, such as polycarbonate or ABS, that is readily bondable using common adhesives.

Additives: Comprising from 0% up to 98% by weight and including tungsten powder at maximum loading to give a density greater than 7 g/cm³. Other possible additives would include antioxidants, UV stabilizers and possible colorants for identification purposes.

The density of the radiation shielding layer preferably will be maximized (greater than 7 g/cm³) for greater shielding of high energy photonic radiation. For use where neutron radiation is also present, it may additionally contain an additive possessing a thermal neutron capture cross section of greater than or equal to 1,000 barns. The form of the composite preferably will be that of a large surface area, rigid or semi-rigid sheet having a high toughness to resist damage during handling and attachment. The sheet preferably will be resistant to moisture, oxidation and UV degradation.

### Example 6

Machinable Honing Preform Formed by Powder Injection Molding

Hard particulate component: medium grain tungsten carbide and/or titanium carbide comprising from 0% up to about 98% by weight and having an average particle size of about 2 microns up to about 5 microns.

Carrier: a polymer comprising from about 2% to about 50% by weight and providing high strength and hardness, but with moderate toughness to promote easy machinability, for example, phenolic polymers.

Additives: tungsten powder and/or titanium powder to balance the abrasive character of the tungsten carbide hard particulate to a desired level and comprising from 0% up to about 50% by weight.

The form of the composite preform preferably will be either near the desired net shape requiring only minimal finish machining or, alternatively, a monolithic shape that is machinable to final desired shape. The carrier and loading levels preferably will be selected to give good machinability. The preform preferably will be resistant to moisture, oxidation and thermal softening.

### Example 7

Extrudable Putty of High Radiographic Density

Hard particulate component: minimal, for example from 0% up to about 1% by weight.

Carrier: a silicone binder comprising from about 5% to about 50% by weight and readily extrudable under low pressure, i.e., less than 689.5 kPa (100 psi).

Additives: comprising from about 50% to about 95% by weight, including tungsten powder at maximum loading to give a density greater than 7 g/cm³. Other additives would include antioxidants, UV stabilizers, stabilizers to inhibit depolymerization, and possible colorants for identification purposes.

The putty will be preferably in a pliable form that can be manually applied to radiation “hot spots”, having variable surfaces, such as cracks. The putty may also be formulated to provide a thermal neutron capture cross section of greater than or equal to 1,000 barns. The putty preferably will be resistant to moisture and have a controlled viscosity, setting within approximately 24 hours at ambient exposure. Various characteristics, such as, for example, curing rate or long term pliability, may be determined by loading amounts of the hard particulates and/or the additive(s) or the nature or design of the binder(s) (such as, for example, solvent volatility).

### Example 8

Fiber Reinforced Conformal Abrasive Sheet

Hard particulate component: wide distribution of tungsten carbide particles, titanium carbide particles, and/or cemented carbide fragments (comprising zirconium carbide, zirconium oxide, tantalum carbide, niobium carbide, hafnium carbide, chromium carbide, vanadium carbide, and the like) comprising from 0% up to about 98% by weight and having an average particle size of about 1 micron up to about 10,000 microns.

Carrier: an elastomer or polymer (such as a phenolic resin) comprising about 2% to about 50% by weight and suitable for fiber reinforcement.

Additives: woven fiber and colorant for identification purposes comprising from 0% up to about 50% by weight.

The abrasive sheet will be preferably a relatively thin, flexible sheet, formulated for controlled wear to continually expose new abrasive grains as older grain surface layers are abraded off. The sheet will also preferably be resistant to moisture and thermal cycling.

### Example 9

Non-Flexible Bonded Abrasive Sheet

A non-flexible bonded abrasive strip was manufactured according to one embodiment of the present disclosure. The resulting strips included tungsten carbide as the hard particulate, a fiber backing as the additive, and a phenol/formaldehyde resin as the binder. The resulting non-flexible abrasive strip could be used, for example, as a skid resistant sheet.

A flexible fiber backing strip (ATI Garryson Ltd., Leicestershire, UK) was coated by squeegee with a 0.1 mm layer of phenol/formaldehyde resin (Cellobond 85S, a liquid phenolic resole commercially available from Hexion Specialty Chemicals, Inc., Columbus, Ohio). A closed layer (complete coverage) of 80 grit tungsten carbide powder (International Diamond Services Inc., Houston, Tex., particle size distribution shown in Table 1) was applied to the phenol/formaldehyde resin by a gravity coater. The tungsten carbide powder was allowed to settle and any wet spots were recoated with additional tungsten carbide powder. The composite material was cured in an oven at 150° C. (300° F.) for 15 minutes and then air cooled.

TABLE 1
Particle Size Distribution of 80 Grit Tungsten Carbide

| Particle size (grit) | Percent |
|---|---|
| +70 | 0% |
| +80 | 19% |
| +100 | 80.1% |
| +120 | 0.9% |
| −120 | 0% |

The resulting dark gray, waterproof abrasive strip had an area density of 0.17 g/cm² and an abrasive life of 500 hrs (as tested using a 13,000 orbits per minute (opm) sander and measuring the change in mass). The strip demonstrated minimal flexibility in a bend radius test.

### Example 10

Non-Flexible Bonded Abrasive Sheet

A non-flexible bonded abrasive strip was manufactured according to one embodiment of the present disclosure. The resulting strips included tungsten carbide as the hard particulate, a fiber backing as the additive, and a phenol/formaldehyde resin as the binder. The resulting non-flexible abrasive strip could be used, for example, as a skid resistant sheet.

The manufacturing process of Example 9 was followed, except that 120 grit tungsten carbide powder (International Diamond Services Inc., Houston, Tex., particle size distribution shown in Table 2) was used instead of 80 grit tungsten carbide. The resulting dark gray, waterproof abrasive strip had an area density of 0.15 g/cm². The strip demonstrated minimal flexibility in a bend radius test.

TABLE 2
Particle Size Distribution of 120 Grit Tungsten Carbide

| Particle size (grit) | Percent |
|---|---|
| +100 | 6.7% |
| +120 | 46% |
| +140 | 41.5% |
| −140 | 5.8% |

### Example 11

Flexible Bonded Abrasive Sheet

A flexible bonded abrasive strip was manufactured according to one embodiment of the present disclosure. The resulting strips included tungsten carbide as the hard particulate, a fiber backing as the additive, and a phenol/formaldehyde resin as the binder.

The manufacturing process of Example 9 was followed, except that 120 grit tungsten carbide powder (International Diamond Services Inc., Houston, Tex.) was used instead of 80 grit tungsten carbide. The resulting dark gray, waterproof abrasive strip had an area density of 0.10 g/cm². The strip was flexible (180° flexibility in the bend radius test) and showed no visible cracking after flexing. Loose grains were observed in an abrasive life test performed with a 10,000 opm sander.

### Example 12

Pliable Tungsten Putty

In this Example, pliable putties containing tungsten powders were formed using two different grades of tungsten powder. The resulting high density putties showed minimal weight loss and water absorption.

Pliable tungsten putties were manufactured using various ratios of tungsten powder to binder. Two grades of tungsten powder were used: tungsten C-20 grade (6 to 9 micron particle size, commercially available from ATI Alldyne, Huntsville, Ala.) and tungsten G-90 grade (25 micron minimum particle size, commercially available from ATI Metalworking Products, La Vergne, Tenn.). The binder comprised a mixture of polybutene (isobutylene/butane co-polymer (INDOPOL® H-35, commercially available from Amoco Chemical Co., Warrenville, Ill.); benzenepropanoic acid, 2,2-bis[[3,5-bis(1,1-dimethylethyl)-4-hydroxyphenyl]-1-oxopropoxy] methyl-1,3-propanediylester (IRGANOX® 1010, commercially available from Ciba Specialty Chemicals Corp., Tarrytown, N.Y.); and styrene ethylene butylenes styrene block co-polymer (KRATON® G-1651H, commercially available from Kraton Polymers, Houston, Tex.). The metal powder and binder were mixed at various volume ratios ranging from 50:50 to 80:20. The tungsten powder was mixed with the binder composition for 15 minutes at 130° C. The compositions of the various putties are set forth in Table 3: Composition of Tungsten Putties.

TABLE 3
Composition of Tungsten Putties

| | Mixing ratio | | Weight of the individual components | | | |
|---|---|---|---|---|---|---|
| | (vol. %) | | Solid | Binders Loading (vol. %) | | |
| | Tungsten | Binders | Tungsten | Kraton G | Irganox | Indopol |
| Powder quality | Loading | Loading | (g) | 1651 (g) | 1010 (g) | H-35 (g) |
| Tungsten G-90 | 50 | 50 | 100.25 | 2.24 | 0.11 | 8.86 |
| grade (25 micron) | 55 | 45 | 110.28 | 2.02 | 0.1 | 7.97 |
| | 60 | 40 | 120.3 | 1.79 | 0.09 | 7.09 |
| | 65 | 35 | 130.33 | 1.57 | 0.08 | 6.2 |
| | 70 | 30 | 140.35 | 1.35 | 0.07 | 5.31 |
| | 75 | 25 | 150.38 | 1.12 | 0.06 | 4.43 |
| Tungsten C-20 | 50 | 50 | 50.38 | 2.24 | 0.11 | 8.86 |
| grade (6-9 micron) | 60 | 40 | 60.45 | 1.79 | 0.09 | 7.09 |
| | 65 | 35 | 65.49 | 1.57 | 0.08 | 6.2 |
| | 70 | 30 | 70.53 | 1.35 | 0.07 | 5.31 |
| | 75 | 25 | 75.56 | 1.12 | 0.06 | 4.43 |
| | 80 | 20 | 80.6 | 0.9 | 0.04 | 3.54 |

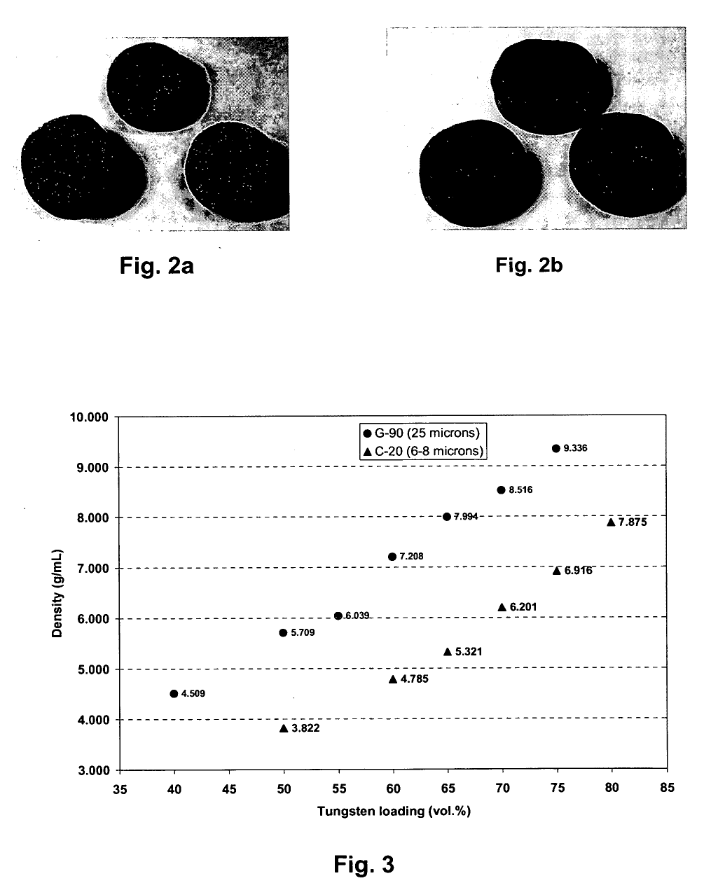

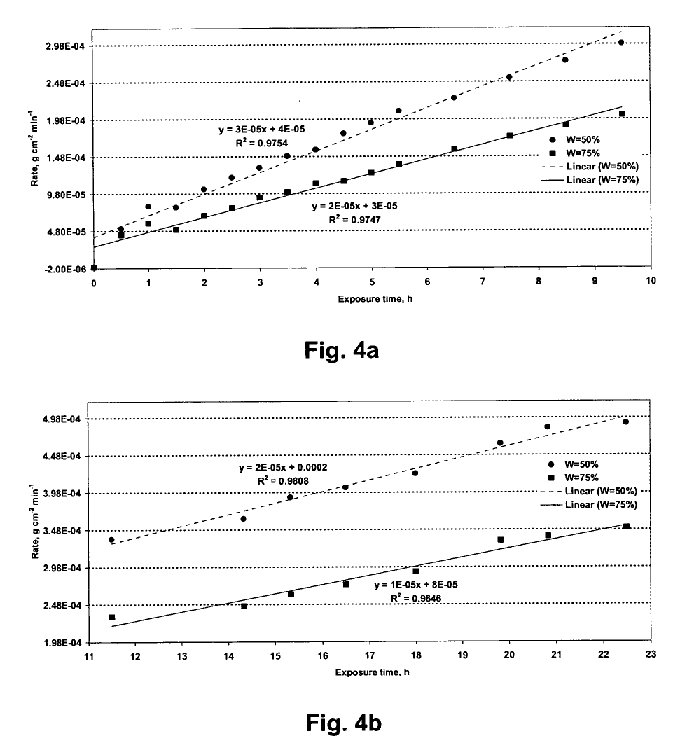

FIGS. 2a and 2b are photographs of putties incorporating 70% G-90 grade tungsten powder (25 micron) and 80% C-20 grade tungsten powder (6-9 micron), respectively. The resulting putties were tested for density, weight loss at 100° C., weight loss upon exposure to ultraviolet (UV) light, and water absorption. Putty density ranged from 3.822 g/cm³ to 9.336 g/cm³ depending on loading volume of tungsten powder. Density of the putties as a function of tungsten loading for both tungsten powder grades (6-9 and 25 microns) are presented in FIG. 3. The rate of weight lost over time was measured while heating at 100° C. The rate of weight loss (g/(cm²min)) as a function of time of heating at 100° C. (hr) is plotted for tungsten powder grades 25 microns at 50% and 70% loadings and 6-9 microns at 50% and 80% loadings are presented in FIGS. 4a-4b and 4c-4d, respectively.

The weight lost over time was measured while exposed to UV radiation. The weight loss (g) as a function of time of exposure to UV radiation (hr) is plotted for both tungsten powder grades 25 microns at 50% and 70% loadings and 6-9 microns at 50% and 80% loadings are presented in FIGS. 5a and 5b, respectively.

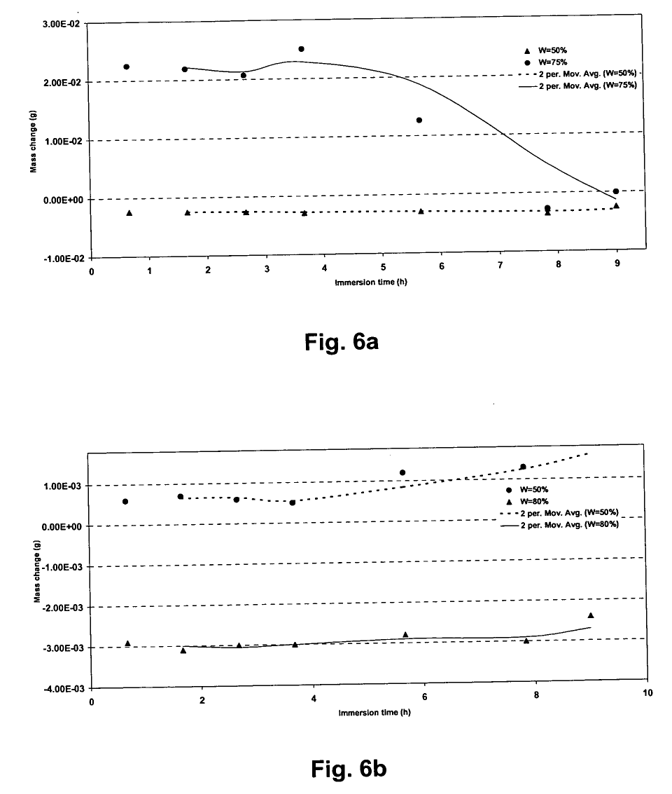

Water absorption of the putties was measured by immersion of the putties in water over 10 hours. The change in mass (g) of the putties as a function of immersion time (hr) is plotted for both tungsten powder grades 25 microns at 50% and 70% loadings and 6-9 microns at 50% and 80% loading are presented in FIGS. 6a and 6b, respectively. As shown in FIGS. 4a-4d and 5a-5b, putties according to certain embodiments may demonstrate different rates of curing and/or loss of weight (for example, due to evaporation of solvent) which corresponds to a putty that remains pliable over time (lower rate and/or weight loss, as demonstrated by a low slope of the line) or a putty that cures to a higher viscosity over time (higher rate and/or weight loss, as demonstrated by a higher slope of the line). Various characteristics, such as, for example, curing rate or long term pliability, may be determined by loading amounts of the hard particulates and/or the additive(s) or the nature or design of the binder(s) (such as, for example, solvent volatility).

1. A composite material comprising:
a hard particulate component selected from the group consisting of tungsten carbide, ditungsten carbide, titanium carbide, crushed cemented carbide, rounded tungsten carbide-containing granules, silicon carbide, boron carbide, aluminum oxide, zirconium carbide, zirconium oxide, tantalum carbide, niobium carbide, hafnium carbide, chromium carbide, vanadium carbide, diamond, boron nitride, and combinations thereof;
an additive component; and
a binder component selected from the group consisting of a rubber, a polymer, an epoxy, a silicone, an elastomer, and combinations thereof.

2. The composite material of claim 1, wherein the composite material comprises more than one hard particulate component.

3. The composite material of claim 1, wherein the additive comprises at least one metal selected from the group consisting of tungsten, titanium, molybdenum, chromium, nickel, iron, cobalt, copper, tin, bismuth, zinc, and silver.

4. The composite material of claim 1, wherein the at least one additive comprises a transition metal-base braze alloy selected from the group consisting of a copper-base braze alloy, a nickel-base braze alloy, a cobalt-base braze alloy, a silver-base braze alloy, a titanium alloy, a Ni—Co base braze alloy, and a Ni—Cu base braze alloy.

5. The composite material of claim 1, wherein the additive is selected from the group consisting of an inorganic property modifier, a processing aid, an antioxidant, a colorant, a brazing flux, a stabilizer, a hardener, a material reducing flow separation of ingredients of the composite material, a material promoting chemical stability of the composite material, a material that modifies at least one mechanical property of the composite material, and a reinforcing material.

6. The composite material of claim 1, wherein the composite material comprises more than one additive selected from the group consisting of a metal, a transition metal-base braze alloy, an inorganic property modifier, a processing aid, an antioxidant, a colorant, a brazing flux, a stabilizer, a hardener, a material reducing flow separation of ingredients of the composite material, a material promoting chemical stability of the composite material, a material that modifies at least one mechanical property of the composite material, and a reinforcing material.

7. The composite material of claim 1, wherein the additive comprises at least one inorganic property modifier selected from the group consisting of a metal oxide powder, a carbonate, a silicate, a hydrate, glass beads, a phosphate, a borate, a magnesium salt, and a small particle size metal.

8. The composite material of claim 1, wherein the additive comprises at least one processing aid selected from the group consisting of a surfactant, a lubricant, a curing agent, a filler-binder couplant, and a mold release agent.

9. The composite material of claim 1, wherein the additive comprises at least one colorant selected from the group consisting of an organic dye, a metal oxide powder, and carbon black.

10. The composite material of claim 1, wherein the binder comprises two or more materials selected from the group consisting of rubbers, polymers, epoxies, silicones, and elastomers.

11. The composite material of claim 1, wherein the binder comprises a rubber selected from the group consisting of natural isoprenes, latex, chloroprene, styrene butadienenitriles, butyls, neoprenes, urethanes, and fluoroelastomers.

12. The composite material of claim 1, wherein the binder comprises a polymer selected from the group consisting of acetal co-polymers, acetal homopolymers, acrylics, ABS, celluloses, polyamides, polyimides, polycarbonates, polybutylene terephthalate, PEEK, PEI, PES, polyolefins, polyesters, polystyrene, PPO, polysulfone, PVC, thermoplastic, polyurethanes, epoxies, phenolics, vinyl esters, and urethane hybrids.

13. The composite material of claim 1, wherein the binder is a retained binder.

14. The composite material of claim 1, wherein the binder is a fugitive binder, wherein the fugitive binder is removed by at least one of heating and contacting with a chemical in the process of applying or using the composite material.

15. The composite material of claim 14, wherein the fugitive binder is removed during the application or use of the composite material by heating using means comprising at least one of a flame, electrical plasma, a laser, a wide area radiant arc light, and a wide area radiant high intensity incandescent light.

16. The composite material of claim 14, wherein substantially all of the fugitive binder is removed during application or use of the composite material.

17. The composite material of claim 14, wherein removal of the fugitive binder results in a residue.

18. The composite material of claim 17, wherein the residue is a fluxing agent.

19. The composite material of claim 17, wherein the residue bonds the hard particulate and the additive to a substrate.

20. The composite material of claim 19, wherein the substrate is one of a face of a rock crushing bit and a surface of a metalworking tool.

21. The composite material of claim 1, wherein the composite material is adapted to be adhered to a surface of a substrate.

22. The composite material of claim 1, wherein the composite material is a molded preform that is machinable to a desired final shape.

23. The composite material of claim 22, wherein the hard particulate comprises at least one of tungsten carbide particles and titanium carbide particles, wherein the particles have an average particle size of 2 microns to 10 microns.

24. The composite material of claim 22, wherein the additive comprises a metal powder present in an amount sufficient to limit the abrasiveness of said hard particulate to a desired level.

25. The composite material of claim 22, wherein the binder is a rigid, high strength polymer.

26. The composite material of claim 1, wherein a maximum solids loading is increased by use of one of a bimodal tailoring, a tri-modal tailoring and a multi-modal tailoring of a particle size distribution of at least one particulate component.

27. A composite material of claim 1, wherein at least one of the density and stiffness are varied by modification of a particle shape of at least one of the hard particulate and the additive.

28. The composite material of claim 1, wherein the composite material is a conformal sheet.

29. The composite material of claim 28, wherein the conformal sheet comprises a hardfacing appliqué, wherein the hard particulate is selected from the group consisting of coarse grain tungsten carbide, coarse grain titanium carbide, coarse grain zirconium carbide, coarse grain zirconium oxide, coarse grain tantalum carbide, coarse grain niobium carbide, coarse grain hafnium carbide, coarse grain chromium carbide, coarse grain vanadium carbide, coarse grain crushed cemented carbide, and combinations thereof; the binder comprises a fugitive binder; and the additive comprises a transition metal-base braze alloy.

30. The composite material of claim 28, wherein the additive comprises tungsten powder in an amount sufficient to give the conformal sheet a density of about 7 g/cm³ to about 12 g/cm³.

31. The composite material of claim 30, wherein the conformal sheet is a radiation shielding layer wherein the conformal sheet is adapted to be adhered to a surface and has a density of about 7 g/cm³ to about 11 g/cm³.

32. The composite material of claim 30, wherein the conformal sheet has a thickness of about 0.050 inches to about 0.150 inches.

33. The composite material of claim 28, wherein the conformal sheet comprises one of a skid-resistant sheet and a friction material adapted to be applied to a surface, wherein the hard particulate is selected from the group consisting of medium grain crushed sintered carbide, zirconium carbide, zirconium oxide, tantalum carbide, niobium carbide, hafnium carbide, chromium carbide, vanadium carbide, titanium carbide, and combinations thereof; and the additive comprises at least one of coarse grain tungsten particles and coarse grain titanium particles.

34. The composite material of claim 33, wherein the one of a skid-resistant sheet and a friction material is adapted to be adhesively bonded to the surface.

35. The composite material of claim 33, wherein the additive comprises one or more of antioxidants, stabilizers, reinforcing fibers, and colorants.

36. The composite material of claim 1, wherein the material is an extrudable putty.

37. The composite material of claim 36, wherein the extrudable putty includes a hard particulate comprising at least one of a tungsten carbide and a titanium carbide, wherein the hard particulate has an average particle size of 2 microns to 5 microns.

38. The composite material of claim 36, wherein the extrudable putty comprises a binder comprising silicone and an additive comprising tungsten powder, wherein the putty has a density of greater than 7 g/cm³ and a high radiographic density.

39. The composite material of claim 36, wherein the putty comprises a solvent and is curable to a higher viscosity by evaporation of the solvent.

40-83. (canceled)

84. A composite material comprising:
a hard particulate component;
an additive component; and
a binder component comprising at least one material selected from the group consisting of a rubber, a polymer, an epoxy, a silicone, and an elastomer,
wherein the composite material has a form selected from the group consisting of a hardfacing appliqué, an extrudable abrasive putty, a high radiographic density extrudable putty, a conformal abrasive sheet, a skid-resistant sheet, a radiation shielding layer, and a molded hard preform.
